(19) United States
(12) Patent Application Publication
(10) Pub. No.: US 2023/0417334 A1
(43) Pub. Date: Dec. 28, 2023

(54) BALL FOR CHECK VALVES

(71) Applicant: KYOCERA Corporation, Kyoto-shi, Kyoto (JP)

(72) Inventor: Shoichi OTA, Higashiomi-shi, Shiga (JP)

(21) Appl. No.: 18/038,879

(22) PCT Filed: Nov. 26, 2021
(86) PCT No.: PCT/JP2021/043463

§ 371 Date: May 25, 2023

(30) Foreign Application Priority Data
Nov. 27, 2020 (JP) 2020-197302

(51) Int. Cl. F16K 15/04

(52) U.S. Cl. CPC F16K 15/04

(57) ABSTRACT

A ball for check valves according to an embodiment of the present disclosure includes: a spherical body, which contains tungsten or platinum as a main constituent; and a film, which is located at the surface of the spherical body and contains a metal compound as a main constituent.

### TECHNICAL FIELD

The present invention relates to a ball for check valves.

### BACKGROUND OF INVENTION

Liquid pumps used in analytical instruments for liquid chromatography or the like are required to have precise flow control. In order to satisfy such a demand, people have been using precision check valves in which a ball is raised by the flow of liquid (for example, Patent Document 1). In general, the ball used in such a check valve is made of ruby or the like, and the ball seat used in such a check valve is made of sapphire or the like.

### CITATION LIST

### Patent Literature

Patent Document 1: WO 2012/023201

### SUMMARY

### Solution to Problem

A ball for check valves according to an embodiment of the present disclosure includes: a spherical body containing tungsten or platinum as a main constituent; and a film located at a surface of the spherical body and containing a metal compound as a main constituent. A check valve according to an embodiment of the present disclosure includes: the ball for check valves described above; and a ball seat that the ball for check valves is contactable to and separable from.

A liquid supplying device according to an embodiment of the present disclosure includes the check valve described above, and a liquid chromatography device according to an embodiment of the present disclosure includes the liquid supplying device described above.

### BRIEF DESCRIPTION OF THE DRAWINGS

FIG. 1 is a cross-sectional view illustrating a check valve provided with a ball for check valves according to an embodiment of the present disclosure.

FIG. 2 is an explanatory drawing illustrating the ball for check valves and a ball seat that are provided in the check valve illustrated in FIG. 1.

### DESCRIPTION OF EMBODIMENTS

As described above, known balls made of ruby have a small specific gravity. As such, it takes time for the known balls to stop a backflow. Meanwhile, when a ball is made of a metal having a specific gravity larger than that of ruby, the surface of the ball is easily corroded in a short time depending on the type of the fluid.

As such, a ball for check valves that has excellent responsiveness when a fluid flows backward and is less likely to be corroded by the fluid is in demand.

A ball for check valves according to an embodiment of the present disclosure includes: a spherical body, which contains tungsten or platinum that have a large specific gravity as a main constituent, and a film, which is located at the surface of the spherical body and contains an oxide or a non-oxide as a main constituent. The ball for check valves according to an embodiment of the present disclosure has excellent responsiveness when a fluid flows backward, and thus can efficiently prevent a backflow. Furthermore, since the ball for check valves according to an embodiment of the present disclosure includes a film containing an oxide or a non-oxide as a main constituent, the ball for check valves is less likely to be corroded by the fluid.

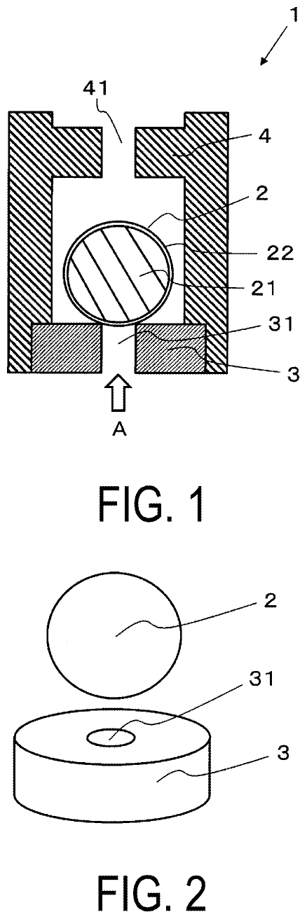

A check valve provided with the ball for check valves according to an embodiment of the present disclosure will be described in detail based on FIG. 1. FIG. 1 is a cross-sectional view illustrating a check valve provided with the ball for check valves according to an embodiment of the present disclosure. A check valve 1 according to an embodiment illustrated in FIG. 1 includes a ball for check valves 2, a ball seat 3, and a casing 4.

The ball for check valves 2 according to an embodiment provided in the check valve 1 includes a spherical body 21 as well as a film 22 located at the surface of the spherical body 21. The spherical body 21 is formed of a metal containing tungsten or platinum as a main constituent. Tungsten and platinum have a large specific gravity, which improves the responsiveness to the backflow of a liquid. In the present specification, a metal containing tungsten or platinum as a main constituent refers to a metal containing tungsten or platinum at a ratio of 50.5 mass % or greater.

When the main constituent is tungsten, the additional constituents may be, for example, molybdenum, iron, nickel, or copper; a tungsten-based sintered alloy may be used. When the main constituent is platinum, the additional constituents may be, for example, palladium, iridium, or ruthenium; examples include Pt 999, Pt 950, Pt 900, Pt 850, Pt·Pm (Pt 750), Pt 650, Pt 585, and Pt 505.

When the spherical body 21 is composed of a tungsten-based sintered alloy, examples of the tungsten-based sintered alloy include a WC—Co-based sintered alloy, a WC—Cr₃C₂—Co-based sintered alloy, a WC—TaC—Co-based sintered alloy, a WC—TiC—Co-based sintered alloy, a WC—NbC—Co-based sintered alloy, a WC—TaC—NbC—Co-based sintered alloy, a WC—TiC—TaC—NbC—Co-based sintered alloy, a WC—TiC—TaC—Co-based sintered alloy, a WC—ZrC—Co-based sintered alloy, a WC—TiC—ZrC—Co-based sintered alloy, a WC—TaC—VC—Co-based sintered alloy, a WC—Cr₃C₂—Co-based sintered alloy, a WC—TiC—Cr₃C₂—Co-based sintered alloy, a WC—Ni-based sintered alloy, a WC—Co—Ni-based sintered alloy, a WC—Cr₃C₂—Mo₂C—Ni-based sintered alloy, a WC—Ti(C,N)—TaC-based sintered alloy, and a WC—Ti(C,N)-based sintered alloy. The composition of the WC—Co-based sintered alloy has a mass ratio of, for example, W:Co:C=from 70.41 to 91.06:from 3.0 to 25.0:from 4.59 to 5.94. The composition of the WC—TaC—NbC—Co-based sintered alloy has a mass ratio of, for example, W:Co:Ta:Nb:C=from 65.7 to 86.3:from 5.8 to 25.0:from 1.4 to 3.1:from 0.3 to 1.5:from 4.7 to 5.8. The composition of the WC—TiC—TaC—NbC—Co-based sintered alloy has a mass ratio of, for example, W:Co:Ta:Ti:Nb:C=from 65.0 to 75.3:from 6.0 to 10.7:from 5.2 to 7.2:from 3.2 to 11.0:from 1.6 to 2.4:from 6.2 to 7.6.

The composition of the WC—TaC—Co-based sintered alloy has a mass ratio of, for example, W:Co:Ta=from 53.51 to 90.30:from 3.5 to 25.0:from 0.30 to 25.33. The composition of the WC—TiC—Co-based sintered alloy has a mass ratio of, for example, W:Co:Ti=from 57.27 to 78.86:from 4.0 to 13.0:from 3.20 to 25.59. The composition of the WC—TiC—TaC—Co-based sintered alloy has a mass ratio of, for example, W:Co:Ta:Ti:C=from to 87.31:from 3.0 to 10.0:from 0.94 to 9.38:from 0.12 to 25.59:from 5.96 to 10.15.

The spherical body 21 preferably has a relative density of from 99.5 mass % to 99.99 mass %. When the relative density of the spherical body 21 is in this range, the substantial mass of the spherical body 21 is increased, and thus the responsiveness to the backflow of a liquid is further improved. The relative density of the spherical body 21 is a percentage of the theoretical density of the spherical body 21 relative to the apparent density of the spherical body 21 calculated in accordance with JIS R 1634:1998. In order to calculate the theoretical density of the spherical body 21, first, the contents of the constituents of the spherical body 21 are calculated using inductively coupled plasma (ICP) emission spectrometry or fluorescent X-ray analysis. Each constituent is identified by an X-ray diffraction method using CuKα beams. For example, in a case in which the identified constituent is tungsten carbide (WC), the value of the content of W determined by ICP emission spectrometry or fluorescent X-ray analysis is converted into tungsten carbide (WC).

Assuming that the constituents of the spherical body 21 are, for example, tungsten carbide (WC) and cobalt (Co), and that the contents thereof are “a” mass % and “b” mass %, respectively, the theoretical density (T.D) of the spherical body 21 can be calculated in accordance with Equation (1) below using values of the theoretical densities of the constituents [tungsten carbide (WC)=15.6 g/cm³, cobalt (Co)=8.9 g/cm³].

T.D=1/[0.01×(a/15.6+b/8.9)] (1)

Crystal particles constituting the main constituent of the spherical body 21 may have an average diameter of 0.15 μm or less (but not 0 μm). When the average diameter of the crystal particles is in this range, the surface of the spherical body 21 can be easily made into a mirror surface by polishing, which will be described later, and the spherical body can have an excellent sphericity. For example, the spherical body 21 has a sphericity of 20 μm or less, and the sphericity can be calculated in accordance with HS B 1501:2009.

The average diameter of the crystal particles is determined by using a scanning electron microscope to measure a polishing mark, obtained by a sphere grinding method using a ball coated with a paste containing diamond abrasive grains, or to measure a polished surface, obtained by polishing a cross section of the spherical body. Specifically, the magnification is set to 1000×, and four straight lines of the same length are drawn in a range with a horizontal length of 112 μm and a vertical length of 80 μm. The average diameter of the crystal particles constituting the main constituent of the spherical body 21 is then determined by dividing the number of crystals present on the four straight lines by the total length of these straight lines. The length of each straight line may be 20 μm.

The spherical body 21 has an average linear expansion coefficient at from 40° C. to 400° C. of, for example, from 5×10⁻⁶/K to 12.5×10⁻⁶/K. When the average linear expansion coefficient of the spherical body 21 is within this range, the difference between the average linear expansion coefficient of the spherical body 21 and the average linear expansion coefficient of the film 22 containing a metal compound as a main constituent, which will be described below, is small, and the film 22 does not easily peel off even when the spherical body 21 is used in an environment with exposure to a fluid having a large temperature difference.

The size of the spherical body 21 is not limited. The spherical body 21 has a diameter of, for example, approximately from 1 mm to 5 mm; the size of the spherical body 21 is set as appropriate depending on the size of the check valve 1.

The film 22 is formed on the spherical body 21 covering the surface of the spherical body 21. The film 22 contains a metal compound as a main constituent. Since the surface of the spherical body 21 is covered by the film 22 containing a metal compound as a main constituent, the resulting ball for check valves 2 has an improved corrosion resistance. In the present specification, a film containing a metal compound as a main constituent refers to a film containing a metal compound at a ratio of 90 mass % or greater.

In addition to the main constituent, the film 22 may contain another metal component, such as 30 mass ppm or less of Al, 2 mass ppm or less of Fe, 3 mass ppm or less of Ti, 3 mass ppm or less of Mg, or 1 mass ppm or less of K. In particular, the film 22 may contain 99.9 mass % or greater of the metal compound. The contents of the constituents of the film 22 may be determined as follows. First, the constituents are identified by an X-ray diffractometer (XRD) employing a CuKα beam. Then, the contents of the elements are determined by a fluorescent X-ray analyzer (XRF) or an ICP emission spectrophotometer (ICP), and the results are converted to the contents of the identified constituents. When the content of an element is too small to be determined by a fluorescent X-ray analyzer (XRF) or an ICP emission spectrophotometer (ICP), the Rietveld method may be used.

The metal compound used in the film 22 is not limited, and examples thereof include a metal oxide, a metal carbide, a metal nitride, and a metal carbonitride. Examples of the metal oxide include aluminum oxide, silicon oxide, titanium oxide, zirconium oxide, and tungsten oxide. Examples of the metal carbide include titanium carbide and silicon carbide. Examples of the metal nitride include titanium nitride, silicon nitride, SiAlON, and tungsten silicide. Examples of the metal carbonitride include titanium carbonitride.

Among these metal compounds, a material of the film 22 is preferably a metal oxide such as aluminum oxide, silicon oxide, titanium oxide, or zirconium oxide. In particular, by using aluminum oxide, silicon oxide, titanium oxide, or zirconium oxide, the film 22 can be formed inexpensively.

The film 22 may have a Vickers hardness of, for example, 1.5 GPa or greater. When the Vickers hardness of the film 22 is 1.5 GPa or greater, the film 22 has an excellent wear resistance. Further, the film 22 can be used for a long period of time since it is less likely to be scratched by mechanical contact from the outside. The Vickers hardness of the film 22 may be obtained by calculating an indentation hardness in accordance with a nanoindentation method stipulated in ISO14577 and then converting the indentation hardness into the Vickers hardness.

The thickness of the film 22 is not limited, and is preferably, for example, approximately from 0.5 μm to 5 μm or less. The thickness of the film 22 may be determined using an image of a polishing mark of the ball for check valves 2 obtained by a sphere grinding method, or an image of a cross section of the ball for check valves 2, the image being taken with an optical microscope. The ball used in the sphere grinding method is coated in advance with a paste containing diamond abrasive grains. The average diameter (D₅₀) of the diamond abrasive grains is set to 2 μm or less; the average diameter (D₅₀) of the diamond abrasive grains may be selected so that the film 22 is easily distinguished from the spherical body 21.

In order to obtain the spherical body 21 having tungsten as a main constituent, for example, powders of tungsten carbide, cobalt, vanadium carbide, chromium carbide, and carbon are used. In order to keep the average diameter of the crystal particles constituting the main constituent at 0.15 μm or less, the average particle diameter of the tungsten carbide powder is preferably kept at 0.12 μm or less, and particularly preferably 0.1 μm or less.

The above powders are weighed, mixed with an organic solvent such as acetone or propanol, and ground. Then, a binder such as a paraffin-based wax is added to the mixture, which is then turned into granules by a spray dryer. The resulting granules are filled in a molding die mounted with a heater, and then subjected to compression molding while being heated. By the simultaneous performance of compression molding and heating of the molding die, pressure is transmitted substantially evenly throughout a powder compact, resulting in a powder compact with few voids.

The heating temperature is higher than the melting temperature of the binder and lower than the evaporation temperature of the binder. For example, when paraffin wax is used, the heating temperature may be from 40° C., which is equivalent to the melting temperature, to 80° C. When the heating temperature is lower than 40° C., paraffin is not sufficiently melted, and the pressure is not evenly transmitted, leading to the tendency of pores being contained. Meanwhile, when the heating temperature is higher than 80° C., bubbles, which are the source of pores, are easily generated due to evaporation of paraffin. The powder compact resulting from heating and forming is kept in vacuum or an inert gas atmosphere at a maximum temperature of from 1300° C. to 1390° C. for from 20 minutes to 3 hours. The sintering method is, for example, a pressureless sintering method such as thermal plasma sintering, microwave sintering, or millimeter wave sintering. In order to obtain a spherical body having a relative density of from 99.5 mass % to 99.99 mass %, a pressure-assisted sintering method such as hot press sintering, spark plasma sintering, ultrahigh voltage sintering, hot isostatic pressure sintering, or high pressure gas reaction sintering may be used.

The rate of temperature rise from 1200° C. to the maximum temperature may be 5° C./min or greater. When the above powders are wet-mixed, OH groups are adsorbed on the surfaces of the powders. Some of the adsorbed OH groups evaporate as moisture at 500° C. or less, but some other adsorbed OH groups remain on the surfaces of the powders and tend to oxidize vanadium and chromium. Oxides of vanadium and chromium react with carbon at a temperature of 1200° C. or greater, generating CO gas.

When the rate of temperature rise from 1200° C. to the maximum temperature is 5° C./min or greater, cobalt liquefies before sintering proceeds on the surface of the spherical body. The generated CO gas moves from the center of the spherical body toward the outer periphery through the liquefied cobalt, and discharges to the outside. Because of such a mechanism, pores that tend to remain inside the spherical body can be reduced.

A method of forming the film 22 at the surface of the spherical body 21 is not limited, and for example, the following method may be adopted. First, the spherical body 21 is degreased with a neutral detergent, an alkaline detergent, or an organic solvent, and then heated to 60° C. or greater to sufficiently remove moisture from the spherical body 21. The reason for removing moisture is to suppress hydrolysis caused by the reaction between moisture and a polysilazane solution which will be described later. By removing water, a dense film is obtained. After the moisture is removed, the surface of the spherical body 21 is coated with a coating material containing a metal compound using a brush, a scrap fabric piece, or the like. Alternatively, the coating material may be sprayed onto the surface of the spherical body 21, or the spherical body 21 may be immersed in the coating material.

Here, the metal compound is, for example, a polysilazane compound. The polysilazane compound is a silazane polymer ((SiH₂NH)ₙ—) in which hydrogen is bonded as a side chain to the —Si—N— bond of a main chain. An example of the coating material is a polysilazane solution obtained by diluting a polysilazane compound with an organic solvent such as xylene or dibutyl ether to a concentration of from 5 mass % to 25 mass %. After coating, the organic solvent is evaporated in an air atmosphere (in which the relative humidity at room temperature is from 10% to 90%) at a temperature of from room temperature to 120° C. for a retention time of from 0.5 hour to 3 hours. After the organic solvent is evaporated, firing is performed in an electric furnace at a temperature of approximately from 350° C. to 600° C. for a retention time of from 0.5 hour to 3 hours.

Firing performed at 350° C. or higher promotes firing of the nitrogen compound contained in the polysilazane compound and improves corrosion resistance. Meanwhile, firing performed at 600° C. or lower suppresses the occurrence of microcracks, which in turn suppresses the oxidation of the surface of the spherical body 21. Firing performed in the above temperature range improves the adhesiveness between the spherical body and the film and allows an excellent thermal shock resistance to be exhibited. Further, even when heating is performed at a high temperature of approximately 800° C., almost no change in appearance is observed, and thus it can be said that thermal resistance and oxidation resistance are high.

Examples of a liquid necessitates corrosion resistance include: an inorganic acid such as hydrochloric acid, sulfuric acid, and nitric acid; an organic acid such as acetic acids; salt water; and an alkaline solution of pH 11 or higher. Examples of a gas necessitates corrosion resistance include SO₂, SO₃, NOₓ, HCl, Cl₂, O₂, and O₃.

By repeating the coating and firing, the film 22 is formed covering the surface of the spherical body 21. The film 22 contains an amorphous silicon oxide as the main constituent and has a smooth surface. Since the film 22 is amorphous, there is less unevenness in film quality due to anisotropic growth of crystals, and voids that tend to occur between crystals are suppressed. As such, the film 22 has a high density and an excellent corrosion resistance. The crystalline structure of silicon oxide may be identified by, for example, Fourier-transform infrared spectroscopy.

The thickness of the film formed by coating performed once and firing performed once, together counted as one cycle, is from 0.01 μm to 0.5 μm. After several cycles (for example, from 5 cycles to 10 cycles), the final thickness of the film may be from 0.05 μm to 5 μm. When the thickness of the film 22 is 0.05 μm or greater, corrosion resistance against the liquid or the gas is sufficiently maintained. When the thickness of the film 22 is 5 μm or less, the occurrence of microcracks that tend to occur inside the film 22 is suppressed. As a result, the possibility that the liquid or the gas comes into contact with the spherical body 21 via the film 22 is reduced, and thus corrosion resistance is sufficiently maintained.

An average value of an arithmetic mean roughness (Ra) in a roughness curve of the surface of the film 22 is not limited, and may be, for example, from 0.05 μm to 0.15 μm. When the average value of the arithmetic mean roughness (Ra) in the roughness curve of the surface of the film 22 is 0.05 μm or greater, the contact angle with respect to pure water is small. As a result, contaminants such as bacteria or microorganisms adhering to the surface of the film 22 can be quickly washed away together with pure water. Meanwhile, when the average value of the arithmetic mean roughness (Ra) in the roughness curve of the surface of the film 22 is 0.15 μm or less, large particles are less likely to detach from the surface of the film 22. As such, large particles are less likely to be caught between the ball for check valves 2 and the ball seat 3, which will be described later. As a result, the liquid backflow prevention effect can be further improved.

An average value of a root mean square slope (RΔq) in a roughness curve of the surface of the film 22 is not limited, and may be, for example, from 0.004 to 0.2. When the average value of the root mean square slope (RΔq) in the roughness curve of the surface of the film 22 is 0.01 or greater, the contact angle with pure water is small. As a result, contaminants such as bacteria or microorganisms adhering to the surface of the film 22 can be quickly washed away together with pure water. Meanwhile, when the average value of the root mean square slope (RΔq) in the roughness curve of the surface of the film 22 is 0.2 or less, large particles are less likely to detach from the surface of the film 22. As such, large particles are less likely to be caught between the ball for check valves 2 and the ball seat 3, which will be described later. As a result, the liquid backflow prevention effect can be further improved.

The arithmetic mean roughness (Ra) in the roughness curve of the surface of the film 22 as well as the root mean square slope (RΔq) in the roughness curve of the surface of the film 22 can be measured in accordance with JIS B 0601:2001 using, for example, a shape analysis laser microscope (VK-X1100 or a successor model of VK-X1100 that is available from Keyence Corporation). The measurement conditions may be as follows: an illumination method of coaxial epi-illumination, a measurement multiplication factor of 480, a cutoff value λs of “None”, a cutoff value λc of 0.08 mm, a cutoff value λf of “None”, a termination effect correction of “On”, and a measurement range of 710 μm×563 μm per spot with a total of two spots to be measured. Measurement of line roughness may be performed by drawing four lines to be measured at approximately equal intervals along the longitudinal direction of the measurement range. The length of each line to be measured is 560 μm. The average value of arithmetic mean roughness (Ra) and the average value of root mean square slope (RΔq) is each an arithmetic mean of a total of eight lines to be measured.

The arithmetic mean roughness (Ra) and the root mean square slope (RΔq) of the surface of the film 22 are heavily affected by the surface of the spherical body 21. As such, the surface of the spherical body 21 may be adjusted in advance in accordance with the required arithmetic mean roughness (Ra) and root mean square slope (RΔq) of the surface of the film 22. For example, in order to keep the average value of the arithmetic mean roughness (Ra) of the surface of the film between 0.05 μm and 0.15 μm, inclusive, the average value of the arithmetic mean roughness (Ra) of the surface of the spherical body 21 may be set to a value between 0.05 μm and 0.15 μm, inclusive, in advance by lapping using diamond abrasive grains. When lapping is employed, the diamond abrasive grains used are contained in a slurry or a paste, and the average diameter (D₅₀) of the diamond abrasive grains is, for example, from 2 μm to 4 μm.

In order to keep the average value of the root mean square slope (RΔq) of the surface of the film 22 between 0.004 and 0.2, inclusive, the average value of the root mean square slope (RΔq) of the surface of the spherical body 21 may be set to a value between 0.004 and inclusive, in advance by lapping using diamond abrasive grains. In addition to the method described above, the surface of the film 22 may be adjusted by polishing. Polishing is performed by, for example, magnetic fluid polishing, brush polishing, or buff polishing. When lapping is employed, the diamond abrasive grains used are contained in a slurry or a paste, and the average diameter (D₅₀) of the diamond abrasive grains is, for example, 0.5 μm or greater and less than 2 μm.

As an example of the ball for check valves according to an embodiment of the present disclosure, a ball for check valves 2 was obtained by forming a film 22, which contains silicon oxide as a main constituent and has a thickness of 1 μm, covering the surface of a spherical body 21, which is made of tungsten and has a diameter of 3.175 mm. The arithmetic mean roughness (Ra) in the roughness curve and the root mean square slope (RΔq) in the roughness curve of the surface of the resulting ball for check valves 2 were measured at two randomly selected spots under the measurement conditions described above. The average value of the arithmetic mean roughness (Ra) of the two spots was 0.0978 μm, and the average value of the root mean square slope (RΔq) of the two spots was 0.0918.

As illustrated in FIG. 1, the check valve 1 according to an embodiment of the present disclosure includes the ball for check valves 2 according to an embodiment and the ball seat 3 that is contactable by the ball for check valves 2. Specifically, in the check valve 1 according to an embodiment, the ball for check valves 2 is movably housed in the internal space of the casing 4, and the ball seat 3 is provided at one end portion of the casing 4 and is contactable by the ball for check valves 2.

The ball seat 3 is formed of, for example, metal, sapphire, or silicon nitride. The size of the ball seat 3 is not limited and is set as appropriate depending on the size of the casing 4. As illustrated in FIG. 2, when the ball seat 3 has a cylindrical shape, the ball seat 3 has, for example, a diameter of approximately from 4 mm to 12 mm and a height (thickness) of approximately from 1 mm to 15 mm.

A through hole 31 serving as a channel of liquid is formed in the ball seat 3. The size of the through hole 31 is set as appropriate depending on the size or application of the check valve 1, the type or flow rate of the liquid, or the like. For example, the through hole 31 has a diameter of approximately from 1 mm to 5 mm.

The casing 4 is formed of, for example, metal. A through hole 41 serving as a channel of liquid is formed in the other end portion of the casing 4, that is, the end portion facing the ball seat 3.

A liquid flows from the direction of the arrow A illustrated in FIG. 1. When the liquid is flowing, the ball for check valves 2 is raised up from the ball seat 3 by the pressure of the liquid, as illustrated in FIG. 2. As a result, the liquid flows through the internal space of the casing 4 and is discharged from the through hole 41 in the casing 4. When the flow of the liquid stops, the ball for check valves 2 that was raised lands on the ball seat 3. As a result, as illustrated in FIG. 1, the ball for check valves 2 comes into contact with the ball seat 3, blocking the through hole 31 (channel) formed in the ball seat 3. The channel is blocked by the ball for check valves 2 when the flow of liquid stops; as such, the ball for check valves 2 has excellent responsiveness when a fluid flows backward and can efficiently prevent a backflow.

The check valve 1 according to an embodiment is provided in, for example, a liquid supplying device. Such a liquid supplying device is provided in a device requiring the supply of liquid. Examples of such a device include a liquid chromatography device, a coating device that discharges a viscous fluid, a brake fluid pressure control device that controls the pressure of brake fluid supplied to a cylinder, and a fuel injection device that controls the starting and stopping of fuel injection. Examples of a device other than the liquid supplying device include an atomization device that crushes a sample such as a powder under high pressure to make the sample finer.

### REFERENCE SIGNS

1 Check valve
2 Ball for check valves
21 Spherical body
22 Film
3 Ball seat
31 Through hole
4 Casing
41 Through hole

1. A ball for check valves comprising:
a spherical body comprising tungsten or platinum as a main constituent; and
a film located at a surface of the spherical body and comprising a metal compound as a main constituent.

2. The ball for check valves according to claim 1, wherein a relative density of the spherical body is from 99.5 mass % to 99.99 mass %.

3. The ball for check valves according to claim 1, wherein an average diameter of crystal particles constituting the main constituent is 0.15 μm or less but not 0 μm.

4. The ball for check valves according to claim 1, wherein the metal compound is a metal oxide.

5. The ball for check valves according to claim 4, wherein the metal oxide is aluminum oxide, silicon oxide, titanium oxide, or zirconium oxide.

6. The ball for check valves according to claim 1, wherein an average value of an arithmetic mean roughness (Ra) in a roughness curve of the surface of the film is from 0.05 μm to 0.15 μm.

7. The ball for check valves according to claim 1, wherein an average value of a root mean square slope (RΔq) in the roughness curve of the surface of the film is from 0.004 to 0.2.

8. A check valve comprising:
the ball for check valves according to claim 1; and
a ball seat that is contactable to and separable from the ball.

9. A liquid supplying device comprising:
the check valve according to claim 8.

10. A liquid chromatography device comprising:
the liquid supplying device according to claim 9.
